(19) United States
(12) Patent Application Publication
(10) Pub. No.: US 2006/0109144 A1
(43) Pub. Date: May 25, 2006

(54) A method and device for customizing a local map with a grid that can be rotated and zoomed

(76) Inventors: Tony Xu, San Antonio, TX (US); Robert William Graham, Dayton, OH (US)

Correspondence Address: A PATENT LAWYER CORP, PC;R WILLIAM GRAHAM, 22 S ST CLAIR ST, DAYTON, OH, 45402, US

(21) Appl. No.: 10/904,683

(22) Filed: Nov. 23, 2004

(51) Int. Cl. G08G 1/123; G01C 21/32

(52) U.S. Cl. 340/995.15; 701/208

(57) ABSTRACT

A method for customizing a local map with a grid that can be rotated and zoomed includes the steps of (a) defining a grid on a map; (b) generating a grid set-up data as a function the defined grid; and (c) employing a computer based device in a manner to receive the grid set-up data and convert a geographical coordinate to a local coordinate on the map. A device for such use includes a computer based device having a processor, a memory operably association with the processor, a power source, means for receiving a geographical coordinate; and geographical coordinate conversion software operably disposed in the memory and operably associated with the processor in a manner to in a manner to receive grid set-up data and convert the received geographical coordinate to a local coordinate on the map.

### BACKGROUND OF THE INVENTION

This invention relates to a method and device for customizing a local map with a grid that can be rotated and zoomed for travel planning, travel guidance, and recording travel locations and paths during business or recreational use, particularly in regard to the linkage of small, memory-limited computers.

### PRIOR ART

Prior devices exist which provide a computer-based travel-planning guide for determining a route between a user selected travel origin and travel destination following user selected intermediate waypoints along the way. Conventional software enables a preferred travel route within user selected constraints. The user can also select among a plurality of types of geographically locatable points of interest (POIs) within a user-defined region of interest along the travel route. A database enables the incorporation of travel information such as graphics, photos, videos, animations, audio and text information about the user selectable POIs along the way as well as about transportation routes and waypoints. From the user selected and user-defined transportation routes, waypoints, and POIs along the travel route, the software constructs a user customized multimedia travelog for preview on a computer display of the user-defined travel route. The user can output a travel plan, i.e.; downloading waypoints electronically and/or printing out maps with route indications and text travel directions.

Such prior mapping devices have been linked for use with the Global Positioning System (GPS), radio location systems, dead reckoning location systems, and hybrid location systems. For example, the GPS satellite system is used with a GPS receiver for displaying waypoint data and limited routing data of the user on the computer display for correlation of location with surface features or mappable features. This is a problem with the current devices. In order to use such devices, significant memory is required to download the map information as to location. Further, the existing map information is limited in its degree of accuracy; concurrency or resolution in order to accommodate a broad appeal of potential users. These devices only allow for some limited degree of enhanced resolution, such as zooming the x-y coordinates in and out on a predefined map, as can be seen in such programs as Mapquest.com™.

A variety of computer hardware and software travel planning aids is currently available on the market primarily for vacation and recreational travel planning. Such aids include the America NavigaTour™ MediAlive™ multimedia travel guide produced by CD Technology, Inc.; the Great Vacations™ Family Travel Guide by Positive Software Solutions to name a few and National Parks of America, a CDROM product of Multicom Publishing, Inc. which contains a directory of all National Parks in the United States. Rand McNally produces a software travel planning product under the trademark TRIPMAKER™ for planning a trip by car in the United States, Canada, and Mexico. The Rand McNally Tripmaker™ software also calculates quickest, shortest, and preferred scenic routes for the trip planner. While the Rand McNally product incorporates a database of many points of interest, the multimedia travelog information appears limited to preplanned scenic tours. Triple A (American Automobile Association) also provides travel planning from starting point to destination point with stopping points in between. These prior systems have limitations.

Another system is a hand-held personal GPS navigation tool that has been developed by the Garmin Corporation of Lenexa, Kans. under the tradename Garmin GPS 45. The Garmin navigation tool incorporates a GPS receiver and a limited character display screen for displaying position information in alphanumeric and graphic characters. Another such system is a hand-held personal GPS navigation tool that has been developed by Trimble Navigation of Austin, Tex., under the trademark Scout GPS™. The Trimble navigation tool incorporates a GPS receiver and a four-line character display for displaying position information in alphanumeric characters. This hand-held GPS system can apparently display alphanumeric position information in a latitude/longitude coordinate system or a Universal Transverse Mercator (U™) coordinate system. The Trimble navigation tool can apparently also display proprietary coordinate system information for locating the position of a user on a standard topographic map. The Trimble GPS navigation tool displays in alphanumeric characters the horizontal and vertical coordinate distances of the user from the southeast corner or southeast reference point of any standard topographic map. Silva Sweden AB and Rockwell International USA have developed a hand-held GPS compass navigator for use on a standard map. The GPS compass navigator incorporates a GPS receiver for locating the user on a standard map. All the prior devices are relatively memory intensive.

The present invention improves on the art. The present invention need only require a small computing and storage capability and the ability to receive a GPS signal and convert the signal to usable data with respect to a paper map. This does away with the need of expensive PDA/GPS devices (although these devices can be used) for purposes as will be described herein.

### OBJECTS OF THE INVENTION

It is an object of the present invention to provide a method and device for customizing a local map with a grid that can be rotated and zoomed for travel planning, travel guidance, and recording travel locations and paths during business or recreational use, particularly in regard to the linkage of small, memory-limited computers/GPS devices.

It is also an object of the present invention to reduce the cost of using GPS technology in association with location-direction aids.

It is another object to provide a device which permits the user to load a GPS device with a pre- or user-defined grid setup data which can include a plurality of grid blocks corresponding to blocks on a particular pre- or user defined paper map such that the GPS device receives the data and converts the data to display local grid coordinates on a screen in a manner such that the view can easily read one's location with respect to the paper map.

The pre- or user defined grid setup data can include grid origin, grid size and grid rotation angle. Thus, the invention provides a very inexpensive means by which very limited data need be transmitted/input and stored to the GPS device in order to enable highly accurate position to be established with respect to a paper map.

For example, the invention has great application for those visiting theme, amusement or national parks with various points of interest capable of being ascertained by defining a grid to cover only the park with a given grid origin, grid size and grid rotation angle covering the park. The GPS device need only receive the specific grid setup data and the user can easily read their location with respect to the paper map. In this regard, the grid setup data can be associated with a particular map by way of indicia printed on the map which can be input into the device. Conversely the park can also provide a detailed and up-to-date local grid map with grid origin, grid size and grid rotation angle data printed on the map so visitors can use the map with their GPS device.

Another example can be understood where a home-base desktop enables a user to select a map grid portion of an on-line map, including the ability to rotate the grid to a desired angle. Upon selecting the grid area, the setup data is generated (which can be printed on the map or otherwise displayed) for input into the GPS device or downloaded via a wired or wire less data link. The present invention is further designed to facilitate in a PDA/GPS configuration the use of the application software to accomplish the use of the grid setup data.

One aspect of the invention is directed to a method for customizing a local map with a grid that can be rotated and zoomed, which includes the steps of (a) defining a grid on a map; (b) generating a grid set-up data as a function the defined grid; and (c) employing a computer based device in a manner to receive the grid set-up data and convert a geographical coordinate to a local coordinate on the map. Another aspect of the invention is directed to a device for customizing a local map with a grid that can be rotated and zoomed, which includes a computer based device having a processor, a memory operably association with the processor, a power source, means for receiving a geographical coordinate; and geographical coordinate conversion software operably disposed in the memory and operably associated with the processor in a manner to in a manner to receive grid set-up data and convert the received geographical coordinate to a local coordinate on the map.

By so providing, the invention achieves a very low cost and energy efficient GPS device which is highly useful in many applications.

### BRIEF DESCRIPTION OF THE DRAWINGS

FIG. 1 depicts a portion of a local grid map.

FIG. 2 depicts a detail of a selected grid.

FIG. 3 shows a GPS device of the present invention depicting coordinates in a block of grid shown in FIG. 2.

FIG. 4 depicts another grid zoomed in on a portion of a local map.

FIG. 5 shows a GPS device of the present invention depicting coordinates in a block of grid shown in FIG. 4.

FIG. 6 shows coordinates outside the grid in FIG. 4.

### DETAILED DESCRIPTION OF A PREFERRED EMBODIMENT

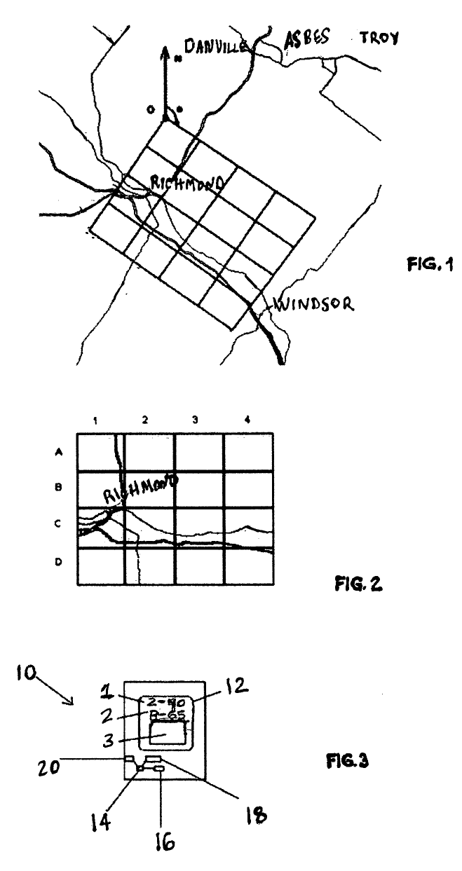

Referring to the drawings, FIG. 1. and FIG. 2. show a local map grid system. The grid represents a particular defined area over a predetermined geographic area. The user-defined grid setup data can include grid origin, grid size and grid rotation angle. As seen in FIG. 1, the grid is rotated a particular angle “α” from due North N zero degrees (0°) and is shown to cover a region covering Richmond toward Windsor. As seen in FIG. 2, the sixteen blocks of the grid are by way of example labeled 1-4 across the left to right and A-D from the top to bottom. Grids themselves on maps have been used in the past in city maps, local area maps like many downtown maps or community maps. Such prior grids were used in these maps helps user to locate a point of interest by narrowing the searching area. However, the grid systems used in those maps usually are not mapped to earth coordinate and are not readily usable with a satellite based location device like a GPS (Global Positioning System) receiver. Such grids were of no useful correlation to a person with a GPS device unless the device included software which essentially included the entire map. This is where the invention departs from prior art.

The present invention bridges the traditional grid map system and a satellite based location device. The present invention includes the use of relatively small and lightweight device 10, such device can be the size of about 1.5×1.5 inches. The device 10 can preferable include a display 12, which can be a liquid crystal display for example. A processor chip 14 is provided therein with relatively small memory 16, for example, 1 K byte RAM, and relatively small power source 18, 3V. Geographical coordinate conversion software is provided in the memory 14 and is operably associated with the processor chip 14. A satellite based location receiver 20 is operably connected to the processor chip 14. With the input of grid setup data which includes grid origin; grid size and grid rotation angle, the processor chip 14 will use the geographical coordinate conversion software to convert the geological coordinates from the satellite based location device 20 into local grid coordinates.

As shown in FIG. 3.: “2-40” identified by the numeral 1 corresponds to horizontal grid number 2 which is 40% from the left while “B-65” identified by the numeral 2 corresponds to vertical grid B which is 65% from the top. There is shown optional graphical display identified by the numeral 5 in FIG. 3. which provides a visual cue of the current location identified by the numeral 3 relative the map grid 2B.

The grid setup data associated with the grid map and can be input by means of keypad, bar code and other scanning method all of which with the device 10 can be operably equipped. The grid setup data also can be input by close range IR/RF signals or downloaded from a PC where the device 10 can include means to accomplish this. Online map services can also send the data via wired or wireless network. For theme park rental device the grid setup data can be permanently written. These are all aspects contemplated within the scope of the invention.

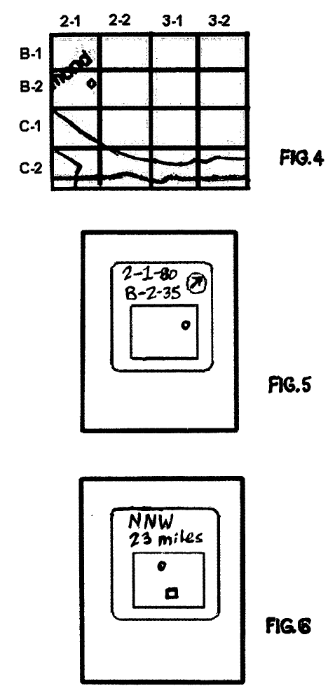

The grid system can be further enhanced by zooming method, see FIG. 4. The zoomed grid map uses the same origin data. The grid number includes a sub level zooming grid. The typical application of the zooming method will be a city map with downtown area enlarged as an insert or separate map. FIG. 5. shows a zoomed location display as well as heading and trace. Note the grid size remains the same as the portion of the map is enlarged.

Rotation angle: The rotation angle is the angle between the North and the horizontal grid line. The default value is 90°. The angle can be any number between 0 and 180°. Rotation map is usually used in areas less than 10×10 Km2. The rotation calculation uses flat earth model for simplicity:

Map origin: O(X0, Y0)

Rotation angle: α

Grid Size: s (length of each side of the grid, in degrees.)

Number of grids: n, m (optional, n: horizontal m: vertical)

Zoom level: z (default 1)

New longitude: X′

New latitude: Y′

Longitude: x

Latitude: Y

X′=(X−X0)*sin(α)+(Y−Y0)*cos(α)

Y′=−(X−X0)*cos(α)+(Y−Y0)*sin(α)

Grid number can be calculated as:

Ix=I if (I−1)×s<X′<=(I+1)×s I=1, 2, 3 . . .

Jy=J if (J−1)×s<Y′<=(J+1)×s J=1, 2, 3 . . .

Percentage in-grid location as:

Px(Ix)=(X′−(Ix−1)×s)/s*100

Py(Jy)=(Y′−(Jy−1)×s)/s*100

Grid coding array can use numbers for horizontal and letters for vertical:

Gx(I)={1, 2, 3, 4, 5, 6, . . . }

Gy(J)={A, B, C, D, E . . . }

Combine G and P we get the representation like:

See FIG. 2.

Ix=2

Iy=2

Gx(2)=2; Px(2)=40 can be displayed as “2-40”

Gy(2)=B; Py(2)=65 can be displayed as “B-65”

If zoom level>1:

Ixz=I if (I−1)×s/z<(X′−Ix*s)<=(I+1)×s/z I=1˜z

Jyz=J if (J−1)×s/z<(Y′−Jx*s)<=(J+1)×s/z J=1˜z

Pxz(Ixz)=((X′−Ix*s)−(Ixz−1)×s/z)/s*z*100

Pyz(Jyz)=((Y′−Jx*s)−(Jyz−1)×s/z)/s*z*100

Gxz(I)={1, 2, 3, 4, 5, 6, . . . }

Gyz(J)={1, 2, 3, 4, 5, 6, . . . }

See FIG. 4:

Ixz=1

Iyz=2

Gxz(1)=1; Pxz(1)=80 can be displayed as “2-1-80”

Gyz(2)=2; Pyz(2)=35 can be displayed as “B-2-35”

To simplify the calculation, all the longitude in the west added a minus sign and then added 180 degrees to all the longitude. All the latitude in the north added a minus sign and then added 90 degree to all the latitude. In this way, the coordinates runs 0-180 degrees from north to south and 0-360 degrees from west to east. Special consideration is needed when the grid covers the area where the west the east separates. In this situation 360 degree is needed to be added to the west longitude to have a valid result. In situations where the location is outside the custom map area, the device can calculate the range and direction to the mapped area and display the related information, as seen in FIG. 6.

While there is shown and described the preferred embodiment of the method and device in accordance with the present invention, it is contemplated that various modifications thereto, still further changes and modifications will suggest themselves to those of ordinary skill in the art. Since these as well as still further changes and modifications are intended to be within the scope of the present invention, the above description should be construed as illustrative and not in a limiting sense, the scope of the invention being defined by the following claims.

What is claimed is:

1. A method for customizing a local map with a grid that can be rotated and zoomed, which includes the steps of:
(a) defining a grid on a map;
(b) generating a grid set-up data as a function said defined grid; and
(c) employing a computer based device in a manner to receive said grid set-up data and convert a geographical coordinate to a local coordinate on said map.

2. The method of claim 1, which includes the step of displaying said local coordinate on a display associated with said computer based device.

3. The method of claim 1, wherein said grid set-up data includes grid origin, grid size and grid rotation angle.

4. The method of claim 1, wherein said grid set-up data is user-defined.

5. The method of claim 1, wherein said grid set-up data is received by means of keypad inputting into said computer based device.

6. The method of claim 1, wherein said grid set-up data is received by means of an IR signal into said computer based device.

7. The method of claim 1, wherein said grid set-up data is received by means of RF signal into said computer based device.

8. The method of claim 1, wherein said grid set-up data is received by means of scanning into said computer based device.

9. The method of claim 1, wherein said grid set-up data is received by means of wired signal into said computer based device.

10. The method of claim 1, which further includes the step of rotating said grid to a desired angle on the map with respect to a predetermined due north position on the map prior to performing step (b).

11. The method of claim 1, which further includes the step of zooming in on a portion of the map prior to performing step (b).

12. The method of claim 1, wherein said computer based device is hand held.

13. A device for customizing a local map with a grid that can be rotated and zoomed, which includes:
a computer based device having a processor, a memory operably association with said processor, a power source, means for receiving a geographical coordinate;
and geographical coordinate conversion software operably disposed in said memory and operably associated with said processor in a manner to in a manner to receive grid set-up data and convert said received geographical coordinate to a local coordinate on said the map.

14. The device of claim 13, which further includes a satellite based location receiver operably connected to said processor chip.

15. The device of claim 13, which further includes a display for displaying said local coordinate thereon.

16. The device of claim 13, which further includes means for user defining a grid on the map; and means for generating a grid set-up data as a function said defined grid defining a grid on a map.

17. The device of claim 13, wherein said grid setup data includes grid origin; grid size and grid rotation angle.

18. The device of claim 16, which further includes means for keypad inputting said grid setup data into said computer based device.

19. The device of claim 16, which further includes means for receiving said grid set-up data via an IR signal.

20. The device of claim 16, which further includes means for receiving said grid set-up data via an RF signal into said computer based device.

21. The device of claim 16, which further includes means for scanning said grid set-up data into said computer based device.

22. The device of claim 16, wherein said defining means is capable of rotating said grid to a desired angle on the map with respect to a predetermined due north position on the map. wherein said defining means is capable of which further includes means for zooming in on a portion of the map prior.
